(19) United States
(12) Patent Application Publication
(10) Pub. No.: US 2014/0210769 A1
(43) Pub. Date: Jul. 31, 2014

(54) SCANNING METHOD, APPARATUS, CONTROLLER AND ELECTRONIC DEVICE BASED ON IN-CELL TECHNIQUE

(71) Applicant: FocalTech Systems, Ltd., George Town (KY)

(72) Inventors: Lianguo LV, Shenzhen (CN); Lihua LI, Shenzhen (CN)

(21) Appl. No.: 13/942,475

(22) Filed: Jul. 15, 2013

(30) Foreign Application Priority Data
Jan. 31, 2013 (CN) 201310040111.0

(51) Int. Cl. G06F 3/044

(52) U.S. Cl. CPC G06F 3/044
USPC 345/174

(57) ABSTRACT

A scanning method, apparatus, controller and electronic device based on an in-cell technique is provided according to the embodiments of the present invention. The scanning method includes: scanning a first region of a liquid crystal display (LCD) during a first period of a scanning cycle; scanning the full screen of a capacitive touch panel (CTP) during a second period of the scanning cycle; scanning a second region of the LCD during a third period of the scanning cycle. By scanning at least two regions of the LCD in a time-sharing manner and by scanning the CTP and the LCD alternatively, according to the embodiments of the present invention, the technical effect of scanning the LCD and the CTP uniformly can be achieved, in the case that there is not the without mutual interference between the scanning of the LCD and the scanning of the CTP.

This application claims the priority to Chinese patent application No. 201310040111.0, titled “SCANNING METHOD, APPARATUS, CONTROLLER AND ELECTRONIC DEVICE BASED ON IN-CELL TECHNIQUE” and filed with the State Intellectual Property Office on Jan. 31, 2013, which is hereby incorporated by reference in its entirety.

### FIELD OF THE INVENTION

The present invention relates to the field of a technology for controlling a touch panel, and particularly to a scanning method, apparatus, controller and electronic device based on an in-cell technique.

### BACKGROUND OF THE INVENTION

In-cell technique refers to a technique in which a capacitive touch function is embedded into liquid crystal pixels. A thin and light panel can be achieved by using the in-cell technique.

In an existing in-cell technique, a touch panel (CTP) and a liquid crystal display (LCD) screen will be scanned to achieve the functions of touch detection and LCD display. In the screen structure based on the existing in-cell technique, in the case of the simultaneous operation of the LCD and CTP, when the thin-film transistor (TFT) of the LCD is switched, a parasitic capacitance will be generated between the TFT and a multi-touch sensor and coupled into the multi-touch sensor, thereby affecting the accuracy of the touch detection. When the CTP is scanned, excitation signals on a multi-touch driver layer may be coupled to a level layer of the LCD, resulting in a fluctuation of the level during the displaying of LCD and the distortion of pixel display.

Accordingly, a problem to be solved by those skilled in the art is to reduce a mutual interference between the CTP and the LCD in the in-cell technique when they operate.

### SUMMARY OF THE INVENTION

In view of this, a scanning method, apparatus, controller and electronic equipment based on an in-cell technique is provided according to the present invention, to reduce a mutual interference between a CTP and an LCD in the in-cell technique when they operate.

In an aspect, in an embodiment of the present invention, a scanning method based on in-cell technique is provided, which includes:

scanning a first region of a liquid crystal display (LCD) during a first period of a scanning cycle;

scanning a full screen of a capacitive touch panel (CTP) during a second period of the scanning cycle; and

scanning a second region of the LCD during a third period of the scanning cycle.

Optionally, the scanning a first region of an LCD includes:

scanning an upper half region of the LCD at a first scanning frame rate.

The scanning a second region of the LCD screen includes:

scanning a lower half region of the LCD at the first scanning frame rate.

Optionally, the scanning a first region of an LCD includes:

scanning odd lines or even lines of the LCD at a first scanning frame rate;

The scanning a second region of the LCD includes:

scanning even lines or odd lines of the LCD at the first scanning frame rate.

Optionally, the scanning a full screen of a CTP includes: scanning the full screen of the CTP at the first scanning frame rate.

Optionally, the scanning the full screen of a CTP includes: scanning the full screen of the CTP at a second scanning frame rate.

The method further includes: scanning the full screen of the CTP at the second scanning frame rate during a fourth period of the scanning cycle, where the second scanning frame rate is twice the first scanning frame rate.

In another aspect, a scanning apparatus based on an in-cell technique is provided according to an embodiment of the present invention, for implementing the scanning method based on the in-cell technique as described above.

In another aspect, a scanning controller based on an in-cell technique is provided according to an embodiment of the present invention, which includes:

a processor and a storage, where the processor reads and performs instructions stored in the storage, and the stored instruction includes:
a first instruction module adapted to scan a first region of a liquid crystal display (LCD) during a first period of a scanning cycle;
a second instruction module adapted to scan a full screen of a capacitive touch panel (CTP) during a second period of the scanning cycle; and
a third instruction module adapted to scan a second region of the LCD during a third period of the scanning cycle.

In another aspect, an electronic device based on an in-cell technique is provided according to an embodiment of the present invention, which includes the scanning controller based on an in-cell technique as described above.

It can be seen from the technical solutions above that, by scanning at least two regions of the LCD in a time-sharing manner and by scanning the CTP and the LCD alternatively, according to the embodiments of the present invention, the technical effect of scanning the LCD and the CTP uniformly can be achieved, in the case that there is not the without mutual interference between the scanning of the LCD and the scanning of the CTP.

### BRIEF DESCRIPTION OF THE DRAWINGS

To illustrate the technical solutions in the embodiments of the present invention or in the prior art more clearly, drawings to be used in describing the embodiments or the prior art will be introduced briefly hereinafter. Apparently, the drawings in the following descriptions are only some embodiments of the present invention, and other drawings can be obtained from the drawings by those skilled in the art without any creative effort.

FIG. 1 is a flow chart of a scanning method based on an in-cell technique provided in an embodiment of the present invention;

FIG. 2a is a flow chart of a scanning method based on an in-cell technique provided in another embodiment of the present invention;

FIG. 2b is a schematic diagram showing a distribution of regions of a LCD in a scanning method based on an in-cell technique provided in an embodiment of the present invention;

FIG. 3a is a flow chart of a scanning method based on an in-cell technique provided in another embodiment of the present invention;

FIG. 3b is a schematic diagram showing a distribution of regions of the LCD in an scanning method based on an in-cell technique provided in an embodiment of the present invention;

FIG. 4 is a flow chart of a scanning method based on an in-cell technique provided in another embodiment of the present invention;

FIG. 5 is a structural schematic diagram of a scanning apparatus based on an in-cell technique provided in an embodiment of the present invention;

FIG. 6 is a structural schematic diagram of a scanning controller based on an in-cell technique provided in an embodiment of the present invention; and

FIG. 7 is an electronic device based on an in-cell technique provided in an embodiment of the present invention.

### DETAILED DESCRIPTION OF THE INVENTION

For the purposes of citation and clearness, technical terms and shortenings or abbreviations of the technical terms used hereinafter illustrates as follows.

LCD indicates Liquid Crystal Display. The construction of an LCD is formed by placing a liquid crystal cell between two glass substrates in parallel, which TFTs (thin-film transistors) are disposed on a lower glass substrate and color filters are disposed on an upper glass substrate. The orientations of liquid crystal molecules are controlled by varying voltages and signals of the TFTs, thereby achieving the purpose of controlling the emergence amount of the polarized light of each pixel, and thus achieving the purpose of displaying.

CTP indicates Capacitive Touch Panel.

The technical solutions in the embodiments of the present invention will be described clearly and completely hereinafter in conjunction with the drawings in the embodiments of the present invention. Apparently, the embodiments described are only a part but not all of the embodiments of the present invention. All the other embodiments obtained by those skilled in the art without creative effort on the basis of the embodiments of the present invention fall within the scope of protection of the present invention.

A scanning method, apparatus, controller and electronic device based on an in-cell technique is provided according to some embodiments of the present invention, to achieve reduction of a mutual interference between a CTP and an LCD in the in-cell technique when they operate.

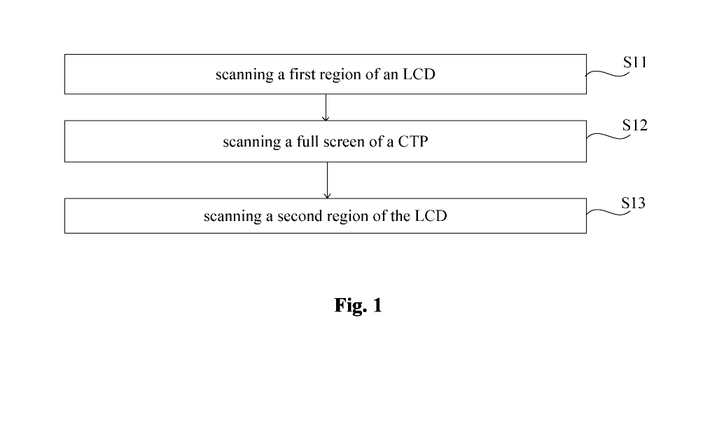

FIG. 1 shows a scanning method based on an in-cell technique, which includes the following steps.

Step S11: scanning a first region of an LCD during a first period of a scanning cycle.

In view of structural arrangements of the LCD and the CTP in the in-cell technique, a problem to be solved is to avoid interference between operation signals of the LCD and the CTP. In the technical solution of the embodiment, the scanning of the CTP and the scanning of the LCD are performed in different periods. More significantly, during the scanning of the LCD, the scanning of the LCD is performed for at least two regions of the LCD respectively, and the scannings for at least two regions of the LCD are spaced by the full screen scanning of the CTP.

Step S12: scanning the full screen of the CTP during a second period of the scanning cycle.

The scannings for at least two regions of the LCD screen are spaced by the scanning of CTP, so as to prevent the situation that a touch on the CTP cannot be detected during a long scanning cycle of the LCD, and improve the timeliness and sensitivity of the touch detection.

Step S13: scanning a second region of the LCD during a third period of the scanning cycle.

In the embodiment, for example, the scanning cycle is 16 ms, the assigned first period may be 5 ms, the assigned second period may be 6 ms, and the assigned third period may be 5 ms, which are not limited to the above time allocation manner.

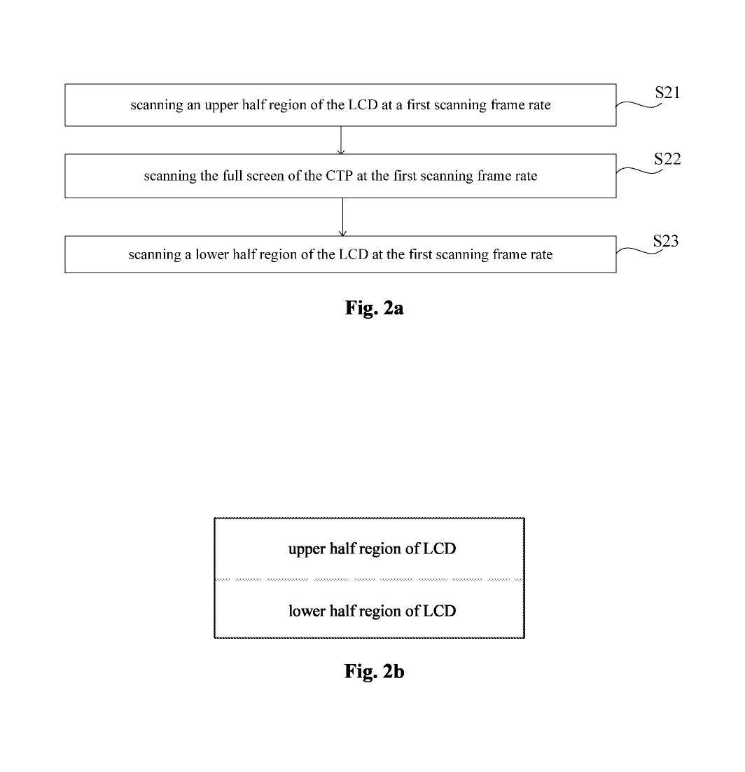

FIG. 2a shows another scanning method based on an in-cell technique, which includes the following steps.

Step S21: scanning an upper half region of an LCD at a first scanning frame rate during a first period of a scanning cycle.

For explaining the embodiment clearly, as an example, the scanning cycle is 16 ms, and the first scanning frame rate can be chosen as 62.5 fps.

Step S22: scanning a full screen of a CTP at the first scanning frame rate during a second period of the scanning cycle.

The scanning frame rate for the full screen of the CTP is 62.5 fps, which is consistent with the scanning frame rate for the LCD.

Step S23: scanning a lower half region of the LCD at the first scanning frame rate during a third period of the scanning cycle.

The above scanning frame rate is obtained by a timing control in a hardware circuit, and the timing control is performed by a processor element in a controller. It should be noted that, compared with the situation in the prior art that interference between the scanning of the LCD and the scanning of the CTP is eliminated by complex wiring, the technical solutions of the present invention can achieve no mutual interference between the scanning of the LCD and the scanning of the CTP, which does not need to change the external wiring of an IC board. The region of the LCD can be distributed in the distribution manner according to the embodiment, i.e., the upper half region and the lower half region, with the number of lines in the upper region being equal to the number of lines in the lower region (the “line” represents the arrangement form of the thin-film transistors (TFT) disposed in the LCD), as seen in FIG. 2b. Of course, other division manners can be used according to the actual operating situation, which will not be limited by this embodiment.

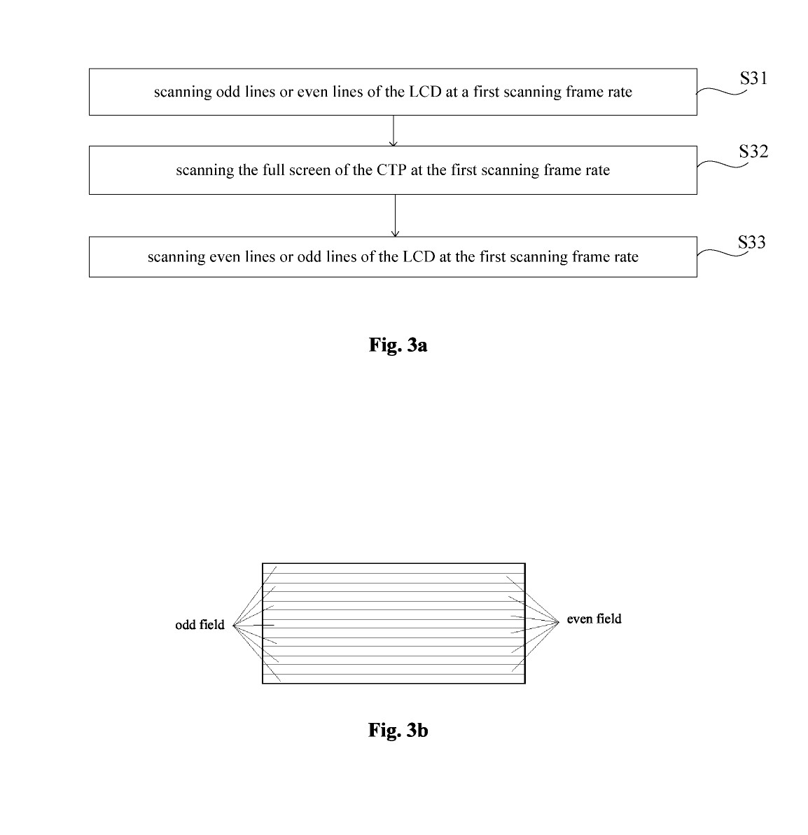

FIG. 3a shows another scanning method based on an in-cell technique, which includes the following steps.

Step S31: scanning odd lines or even lines of an LCD at a first scanning frame rate during a first period of a scanning cycle.

For explaining the embodiment clearly, as an example, the scanning cycle is 16 ms, the first scanning frame rate can be chosen as 62.5 fps.

Step S32: scanning a full screen of a CTP at the first scanning frame rate during a second period of the scanning cycle.

The scanning frame rate for the full screen scanning of the CTP can also be 62.5 fps, which is consistent with the scanning frame rate for each region of the LCD.

Step S33: scanning even lines or odd lines of the LCD at the first scanning frame rate during a third period of the scanning cycle.

The region of the LCD can be distributed in the distribution manner according to the embodiment, i.e., the LCD can be divided into the odd line region or the even line region. In implementation of this solution, if the odd line region (or called “odd field”) is scanned during the first period, the even line region (or called “even field”) which has not suffered the scanning is scanned during the third period, as seen in FIG. 3b. Of course, other division manners can also be used according to the actual operating situation. For example, the even line region is scanned firstly, and then the odd line region which has not suffered the scanning is scanned during the third period, which will not be limited by the embodiment.

FIG. 4 shows another scanning method based on an in-cell technique, which includes the follow steps.

Step S41: scanning a first region of an LCD at a first scanning frame rate during a first period of a scanning cycle.

Step S42: scanning a full screen of a CTP at a second scanning frame rate during a second period of the scanning cycle, where the second scanning frame rate is twice the first scanning frame rate.

Step S43: scanning a second region of the LCD at the first scanning frame rate during a third period of the scanning cycle.

Step S44: scanning the full screen of the CTP at the second scanning frame rate during a fourth period of the scanning cycle, where the second scanning frame rate is twice the first scanning frame rate.

In the embodiment, the scannings of the LCD and the CTP without mutual interference can be achieved by scanning the first region of the LCD, scanning the full screen of the CTP, and scanning the second region of the LCD. The scanning of CTP is performed twice in one scanning cycle, so as to improve the scanning accuracy of the CTP. For ensuring that the scanning of the LCD and the scanning of the CTP can be completed in a preset period, the scanning frame rate for the CTP may be chosen as twice the first scanning frame rate. For example, the scanning cycle is 16 ms, the first scanning frame rate may be chosen as 62.5 fps, and the second scanning frame rate is 125 fps. The first period may be allocated as 5 ms, the second period may be allocated as 3 ms, the third period may be allocated as 5 ms, and the fourth period may be allocated as 3 ms. Such allocations of frame rate and time effectively prevent the failure of the touch detection during the scanning of the LCD, and improves the uniformity and sensitivity of the LCD display and the touch detection.

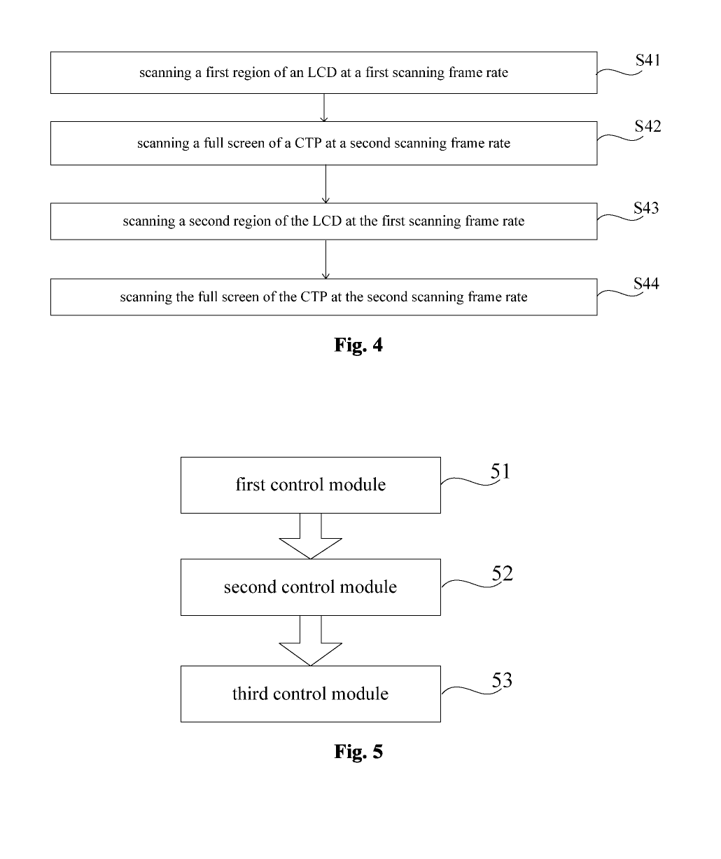

FIG. 5 shows a scanning apparatus based on an in-cell technique, for implementing the scanning method based on the in-cell technique corresponding to the embodiments in FIGS. 1 to 4.

As an example, the scanning apparatus may includes:

a first control module 51 adapted to scan a first region of an LCD during a first period of a scanning cycle;

a second control module 52 adapted to scan a full screen of a CTP during a second period of the scanning cycle; and a third control module 53 adapted to scan a second region of the LCD during a third period of the scanning cycle.

The above apparatus includes functional modules corresponding to steps of the methods illustrated in FIG. 1 and in the embodiments. The apparatus defined by such functional modules is a functional module architecture to realize the technical solution of the present invention. Embodiments corresponding to the FIG. 1 to FIG. 4 will not be described in detail herein, and the subordinate functions and the added functions of the functional modules are also not be listed and described in detail.

Further, it should be noted that the embodiment of the apparatus described above is only schematic, in which the units illustrated as separate parts may be or not be physically-separated parts, the above functional modules may be or not be physical units, i.e. they may be in one place, or may also be distributed onto a plurality of network units. This can be understood and implemented by those skilled in the art without any creative work.

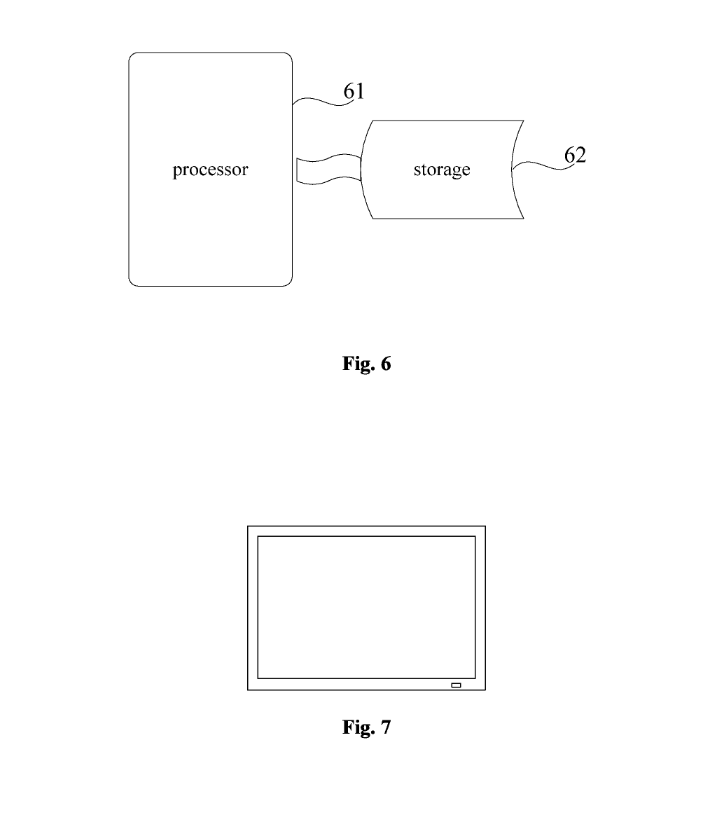

FIG. 6 shows a scanning controller based on an in-cell technique, which includes a processor 61 and a storage 62.

The processor reads and performs instructions stored in the storage, the stored instructions includes:

a first instruction module adapted to scan a first region of an LCD during a first period of a scanning cycle;

a second instruction module adapted to scan a full screen of a CTP during a second period of the scanning cycle; and

a third instruction module adapted to scan a second region of the LCD during a third period of the scanning cycle.

Optionally, the first instruction module is adapted to scan an upper half region of the LCD at a first scanning frame rate.

The third instruction module is adapted to scan a lower half region of the LCD at the first scanning frame rate.

Optionally, the first instruction module is adapted to scan odd lines or even lines of the LCD at a first scanning frame rate.

The third instruction module is adapted to scan even lines or odd lines of the LCD at the first scanning frame rate.

On the basis of the implementation manner described above, the second instruction module is adapted to scan the full screen of the CTP at the first scanning frame rate.

On the basis of the implementation manner described above, the second instruction module is adapted to scan the full screen of the CTP at a second scanning frame rate.

The stored instruction further includes: a fourth instruction module adapted to scan the full screen of the CTP at the second scanning frame rate during a fourth period of the scanning cycle, where the second scanning frame rate is twice the first scanning frame rate.

Those skilled in the art can understand that, the implementation of all or partial processes in the method of the above embodiments can be obtained by instructing relevant hardware via computer programs, the computer program can be stored in a computer readable storage medium, and when executed, the computer program can include processes in the embodiments of the above methods. The storage medium described can be a disc, optical disc, Read-Only Memory (ROM), Random Access Memory (RAM) or the like.

FIG. 7 shows an electronic device based on an in-cell technique, which includes the scanning controller based on an in-cell technique corresponding to the embodiment in FIG. 6.

The electronic device may be a touch panel cellphone, tablet PC, laptop computer integrated with a tablet PC function, and other electronic devices integrated with a tablet PC function based on the in-cell technique.

The controller may be a control chip for controlling or instructing the electronic device to perform touch recognition and LCD display, and the control chip includes a processor and an on-chip memory.

Summarily, according to the embodiments of the present invention, by scanning at least two regions of the LCD in a time-sharing manner and by scanning the CTP and the LCD alternatively, the technical effect of scanning the LCD and the CTP uniformly can be achieved, in the case that there is not the mutual interference between the scanning of the LCD and the scanning of the CTP.

The embodiments of the invention are described herein in a progressive manner, with the emphasis of each of the embodiments on the difference between it and the other embodiments; hence, for the same or similar parts between the embodiments, one can refer to the other embodiments. For the apparatus provided in the embodiments, it corresponds to the method provided in the embodiments, so it is described simply, and for the relevant portions, one can refer to explanations of the method part.

The description of the embodiments herein enables those skilled in the art to implement or use the invention. Numerous modifications to the embodiments will be apparent to those skilled in the art, and the general principle herein can be implemented in other embodiments without deviation from the spirit or scope of the invention. Therefore, the invention will not be limited to the embodiments described herein, but in accordance with the widest scope consistent with the principle and novel features provided herein.

It should be noted that terminologies such as “a first”, “a second”, “the first”, “the second” herein are just used in distinguishing one entity or operation from another entity or operation, and are not bound to require or imply any kind of the actual relationship or sequence existing between these entities and operations. Moreover, terminologies “include”, “comprise” or any other variations are intended to cover all nonexclusive containing, such that a process, method, article, or equipment including a series of elements includes not only the listed elements, but also other elements not listed specifically, or includes the inherent elements thereof. Without more restrictions, the element defined by the sentence “including/comprising a . . . ” does not exclude that the process, method, article, or equipment includes more than one of that element.

1. A scanning method based on an in-cell technique, comprising:
scanning a first region of a liquid crystal display (LCD) during a first period of a scanning cycle;
scanning a full screen of a capacitive touch panel (CTP) during a second period of the scanning cycle; and
scanning a second region of the LCD during a third period of the scanning cycle.

2. The scanning method based on the in-cell technique according to claim 1, wherein
the scanning a first region of an LCD comprises:
scanning an upper half region of the LCD at a first scanning frame rate; and
the scanning a second region of the LCD comprises:
scanning a lower half region of the LCD at the first scanning frame rate.

3. The scanning method based on the in-cell technique according to claim 1, wherein
the scanning a first region of an LCD comprises:
scanning odd lines or even lines of the LCD at a first scanning frame rate; and
the scanning a second region of the LCD comprises:
scanning even lines or odd lines of the LCD at the first scanning frame rate.

4. The scanning method based on the in-cell technique according to claim 2, wherein the scanning a full screen of a CTP comprises: scanning the full screen of the CTP at the first scanning frame rate.

5. The scanning method based on the in-cell technique according to claim 2, wherein
the scanning a full screen of a CTP comprises: scanning the full screen of the CTP at a second scanning frame rate; and
the scanning method based on the in-cell technique further comprises: scanning the full screen of the CTP at the second scanning frame rate during a fourth period of the scanning cycle, where the second scanning frame rate is twice the first scanning frame rate.

6. A scanning apparatus based on an in-cell technique, comprising a processor adapted to
scan a first region of a liquid crystal display (LCD) during a first period of a scanning cycle;
scan a full screen of a capacitive touch panel (CTP) during a second period of the scanning cycle; and
scan a second region of the LCD during a third period of the scanning cycle.

7. A scanning controller based on an in-cell technique, comprising a processor and a storage, wherein the processor reads and performs instructions stored in the storage, and the stored instructions comprise:
a first instruction module adapted to scan a first region of a liquid crystal display (LCD) during a first period of a scanning cycle;
a second instruction module adapted to scan a full screen of a capacitive touch panel (CTP) during a second period of the scanning cycle; and
a third instruction module adapted to scan a second region of the LCD during a third period of the scanning cycle.

8. The scanning controller based on the in-cell technique according to claim 7, wherein
the first instruction module adapted to scan an upper half region of the LCD at a first scanning frame rate; and
the third instruction module adapted to scan a lower half region of the LCD at the first scanning frame rate.

9. The scanning controller based on the in-cell technique according to claim 7, wherein
the first instruction module adapted to scan odd lines or even lines of the LCD at a first scanning frame rate;
the third instruction module adapted to scan even lines or odd lines of the LCD at the first scanning frame rate.

10. The scanning controller based on the in-cell technique according to claim 8, wherein
the second instruction module adapted to scan the full screen of the CTP at the first scanning frame rate.

11. The scanning controller based on the in-cell technique according to claim 8, wherein
the second instruction module adapted to scan the full screen of the CTP at a second scanning frame rate; and
the stored instructions further comprise a fourth instruction module adapted to scan the full screen of the CTP at the second scanning frame rate during a fourth period of the scanning cycle, where the second scanning frame rate is twice the first scanning frame rate.

12. An electronic device based on an in-cell technique, comprising a scanning controller based on an in-cell technique, wherein the scanning controller comprises a processor and a storage, the processor reads and performs instructions stored in the storage, and the stored instructions comprise:
a first instruction module adapted to scan a first region of a liquid crystal display (LCD) during a first period of a scanning cycle;
a second instruction module adapted to scan a full screen of a capacitive touch panel (CTP) during a second period of the scanning cycle; and
a third instruction module adapted to scan a second region of the LCD during a third period of the scanning cycle.

13. The scanning method based on the in-cell technique according to claim 3, wherein the scanning a full screen of a CTP comprises: scanning the full screen of the CTP at the first scanning frame rate.

14. The scanning method based on the in-cell technique according to claim 3, wherein
the scanning a full screen of a CTP comprises: scanning the full screen of the CTP at a second scanning frame rate; and
the scanning method based on the in-cell technique further comprises: scanning the full screen of the CTP at the second scanning frame rate during a fourth period of the scanning cycle, where the second scanning frame rate is twice the first scanning frame rate.

15. The scanning controller based on the in-cell technique according to claim 9, wherein
the second instruction module adapted to scan the full screen of the CTP at the first scanning frame rate.

16. The scanning controller based on the in-cell technique according to claim 9, wherein
the second instruction module adapted to scan the full screen of the CTP at a second scanning frame rate; and
the stored instructions further comprise a fourth instruction module adapted to scan the full screen of the CTP at the second scanning frame rate during a fourth period of the scanning cycle, where the second scanning frame rate is twice the first scanning frame rate.
